(19) United States
(12) Patent Application Publication
(10) Pub. No.: US 2026/0127174 A1
(43) Pub. Date: May 7, 2026

(54) DATA QUERY METHOD AND APPARATUS, ELECTRONIC DEVICE, AND STORAGE MEDIUM

(71) Applicant: BEIJING OCEANBASE TECHNOLOGY CO., LTD., Beijing (CN)

(72) Inventors: Qinliang XUE, Hangzhou (CN); Yifei Tian, Hangzhou (CN); Tao Zhu, Hangzhou (CN); Guoping Wang, Hangzhou (CN)

(21) Appl. No.: 19/437,093

(22) Filed: Dec. 30, 2025

Related U.S. Application Data
(63) Continuation of application No. PCT/CN2024/126920, filed on Oct. 24, 2024.

(30) Foreign Application Priority Data
Dec. 1, 2023 (CN) 202311641470.1

(51) Int. Cl. G06F 16/2453

(52) U.S. Cl. CPC G06F 16/24544; G06F 16/24537

(57) ABSTRACT

The present application relates to the field of database technologies, and provides a data query method and apparatus, an electronic device, and a storage medium. The data query method includes: obtaining a first query statement to be queried; determining, based on the first query statement, a first data table and a second data table to be used for an inner join operation, a first join column to be used for the inner join operation in the first data table, and a second join column to be used for the inner join operation in the second data table; determining, based on the first query statement, whether the first join column and the second join column satisfy a data pushdown condition; in response to determining that the data pushdown condition is satisfied, updating the first query statement to obtain a second query statement; and performing data query on the first data table and the second data table based on the second query statement, to obtain a data query result. As such, a data table can be first filtered, and then an inner join operation is performed, thereby reducing a data processing amount and improving data query performance.

### TECHNICAL FIELD

The present application relates to the field of database technologies, and specifically to a data query method and apparatus, an electronic device, and a storage medium.

### BACKGROUND

In actual service processing scenarios, an inner join operation usually needs to be performed on two data tables to obtain a query result set that includes joined rows, and then data limitation is performed on the query result set via limit clauses such as limit (limit). The inner join operation is to query rows that satisfy an equi-matching condition in the two data tables, and combine matched rows.

### SUMMARY

Implementations of the present application provide a data query method and apparatus, an electronic device, and a storage medium, which improve data query performance during data query.

Inventors recognized that when the inner join operation and data limitation are performed on two data tables, there are usually a relatively large quantity of invalid calculations, which consume a large quantity of system resources and time costs, resulting in poor data query performance.

An implementation of the present application provides a data query method, including: obtaining a first query statement to be queried, the first query statement being a statement to be used to perform inner join on two data tables and then perform data limitation based on a limit clause; determining, based on the first query statement, a first data table and a second data table to be used for an inner join operation, a first join column to be used for the inner join operation in the first data table, and a second join column to be used for the inner join operation in the second data table; determining, based on the first query statement, whether the first join column and the second join column satisfy a data pushdown condition, the data pushdown condition being determined based on whether there is an inclusion relationship between a domain of the first join column and a domain of the second join column; in response to determining that the data pushdown condition is satisfied, updating the first query statement to obtain a second query statement, the second query statement to be used to perform data limitation and then perform an inner join operation on the data tables; and performing data query on the first data table and the second data table based on the second query statement, to obtain a data query result.

In some implementations, the determining, based on the first query statement, whether the first join column and the second join column satisfy the data pushdown condition includes: determining, based on the first query statement, whether an inclusion relationship determining condition is satisfied, the inclusion relationship determining condition being determined based on a data table composition manner; in response to determining that the inclusion relationship determining condition is satisfied and there is a foreign key constraint relationship between the first join column and the second join column or the inner join operation is a self join operation, determining that there is the inclusion relationship; and determining, based on a specified predicate operator included in the first query statement in addition to an inner join clause, whether the data pushdown condition is satisfied, the inner join clause being a clause to be used for the inner join operation in the first query statement.

In some implementations, the determining, based on the first query statement, whether the inclusion relationship determining condition is satisfied includes: in response to determining, based on the first query statement, that both the first data table and the second data table are base tables, determining that the inclusion relationship determining condition is satisfied; and in response to determining, based on the first query statement, that there is a derived table in one or more of the first data table or the second data table, determining, based on a subquery statement corresponding to the derived table, whether the inclusion relationship determining condition is satisfied, the derived table being a virtual table formed based on a subquery statement in the first query statement.

In some implementations, the determining, based on the subquery statement corresponding to the derived table, whether the inclusion relationship determining condition is satisfied includes: in response to determining that the subquery statement includes a specified join operator, determining that the inclusion relationship determining condition is not satisfied; in response to determining that the subquery statement includes an aggregation operator for a join column operation and does not include an extremum operator for an output operation of the aggregation operator, determining that the inclusion relationship determining condition is not satisfied; in response to determining that the subquery statement includes a specified filter operator and a filter range of the specified filter operator does not satisfy a specified filter condition, determining that the inclusion relationship determining condition is not satisfied; in response to determining that the subquery statement includes none of the specified join operator, the aggregation operator, and the specified filter operator, determining that the inclusion relationship determining condition is satisfied; in response to determining that the subquery statement includes the aggregation operator and the extremum operator and includes neither of the specified join operator and the specified filter operator, determining that the inclusion relationship determining condition is satisfied; or in response to determining that the subquery statement includes the aggregation operator, the extremum operator, and the specified filter operator and does not include the specified join operator, and the specified filter condition is satisfied, determining that the inclusion relationship determining condition is satisfied.

In some implementations, the in response to determining that the subquery statement includes the specified filter operator and the filter range of the specified filter operator does not satisfy the specified filter condition, determining that the inclusion relationship determining condition is not satisfied includes: separately determining filter ranges of the first data table and the second data table based on the specified filter operator; and in response to that there is no coverage relationship between the filter ranges respectively corresponding to the first data table and the second data table, determining that the specified filter condition is not satisfied.

In some implementations, the determining, based on the specified predicate operator included in the first query statement in addition to the inner join clause, whether the data pushdown condition is satisfied includes: in response to determining that the first query statement does not include the specified predicate operator, determining that the data pushdown condition is satisfied, or in response to determining that the first query statement includes the specified predicate operator, determining that the data pushdown condition is not satisfied; or in response to determining that the first query statement further includes the specified predicate operator and an associated data table of the specified predicate operator is consistent with a data table to which an included join column belongs, determining that the data pushdown condition is satisfied, or in response to determining that the first query statement does not include the specified predicate operator or the associated data table of the specified predicate operator is inconsistent with the data table to which the included join column belongs, determining that the data pushdown condition is not satisfied, the associated data table being a data table operated by the specified predicate operator.

In some implementations, the updating the first query statement, to obtain the second query statement includes: using a data table, to which an included join column belongs, as a target data table based on the inclusion relationship; generating, based on the limit clause in the first query statement, a target clause to be used to perform data limitation on the target data table; generating a conditional clause to be used to restrain that a join column of the target data table is not null; and combining the first query statement, the target clause, and the conditional clause to obtain the second query statement.

An implementation of the present application provides a data query apparatus, including: an acquisition unit, configured to obtain a first query statement to be queried, the first query statement being a statement to be used to perform inner join on two data tables and then perform data limitation based on a limit clause; a determining unit, configured to determine, based on the first query statement, a first data table and a second data table to be used for an inner join operation, a first join column to be used for the inner join operation in the first data table, and a second join column to be used for the inner join operation in the second data table; a judgement unit, configured to determine, based on the first query statement, whether the first join column and the second join column satisfy a data pushdown condition, the data pushdown condition being determined based on whether there is an inclusion relationship between a domain of the first join column and a domain of the second join column; an update unit, configured to: in response to determining that the data pushdown condition is satisfied, update the first query statement to obtain a second query statement, the second query statement to be used to perform data limitation and then perform an inner join operation on the data tables; and a query unit, configured to perform data query on the first data table and the second data table based on the second query statement, to obtain a data query result.

In some implementations, the judgement unit is configured to: determine, based on the first query statement, whether an inclusion relationship determining condition is satisfied, the inclusion relationship determining condition being determined based on a data table composition manner; in response to determining that the inclusion relationship determining condition is satisfied and there is a foreign key constraint relationship between the first join column and the second join column or the inner join operation is a self join operation, determine that there is the inclusion relationship; and determine, based on a specified predicate operator included in the first query statement in addition to an inner join clause, whether the data pushdown condition is satisfied, the inner join clause being a clause to be used for the inner join operation in the first query statement.

In some implementations, the judgement unit is configured to: in response to determining, based on the first query statement, that both the first data table and the second data table are base tables, determine that the inclusion relationship determining condition is satisfied; and in response to determining, based on the first query statement, that there is a derived table in one or more of the first data table or the second data table, determine, based on a subquery statement corresponding to the derived table, whether the inclusion relationship determining condition is satisfied, the derived table being a virtual table formed based on a subquery statement in the first query statement.

In some implementations, the judgement unit is configured to: in response to determining that the subquery statement includes a specified join operator, determine that the inclusion relationship determining condition is not satisfied; in response to determining that the subquery statement includes an aggregation operator for a join column operation and does not include an extremum operator for an output operation of the aggregation operator, determine that the inclusion relationship determining condition is not satisfied; in response to determining that the subquery statement includes a specified filter operator and a filter range of the specified filter operator does not satisfy a specified filter condition, determine that the inclusion relationship determining condition is not satisfied; in response to determining that the subquery statement includes none of the specified join operator, the aggregation operator, and the specified filter operator, determine that the inclusion relationship determining condition is satisfied; in response to determining that the subquery statement includes the aggregation operator and the extremum operator and includes neither of the specified join operator and the specified filter operator, determine that the inclusion relationship determining condition is satisfied; or in response to determining that the subquery statement includes the aggregation operator, the extremum operator, and the specified filter operator and does not include the specified join operator, and the specified filter condition is satisfied, determine that the inclusion relationship determining condition is satisfied.

In some implementations, the judgement unit is configured to: separately determine filter ranges of the first data table and the second data table based on the specified filter operator; and in response to that there is no coverage relationship between the filter ranges respectively corresponding to the first data table and the second data table, determine that the specified filter condition is not satisfied.

In some implementations, the judgement unit is configured to: in response to determining that the first query statement does not include the specified predicate operator, determine that the data pushdown condition is satisfied, or in response to determining that the first query statement includes the specified predicate operator, determine that the data pushdown condition is not satisfied; or in response to determining that the first query statement further includes the specified predicate operator and an associated data table of the specified predicate operator is consistent with a data table to which an included join column belongs, determine that the data pushdown condition is satisfied, or in response to determining that the first query statement does not include the specified predicate operator or the associated data table of the specified predicate operator is inconsistent with the data table to which the included join column belongs, determine that the data pushdown condition is not satisfied, the associated data table being a data table operated by the specified predicate operator.

In some implementations, the update unit is configured to: use a data table, to which an included join column belongs, as a target data table based on the inclusion relationship; generate, based on the limit clause in the first query statement, a target clause to be used to perform data limitation on the target data table; generate a conditional clause to be used to restrain that a join column of the target data table is not null; and combine the first query statement, the target clause, and the conditional clause to obtain the second query statement.

An implementation of the present application provides an electronic device, including: a processor; and a memory, storing computer instructions. The computer instructions are used to enable the processor to perform the steps of the method provided in any one of the above optional implementations of data query.

An implementation of the present application provides a storage medium, storing computer instructions. The computer instructions are used to enable a computer to perform the steps of the method provided in any one of the above optional implementations of data query.

In the data query method and apparatus, the electronic device, and the storage medium that are provided in the implementations of the present application, a first query statement to be queried is obtained, the first query statement being a statement to be used to perform inner join on two data tables and then perform data limitation based on a limit clause; a first data table and a second data table to be used for an inner join operation, a first join column to be used for the inner join operation in the first data table, and a second join column to be used for the inner join operation in the second data table are determined based on the first query statement; whether the first join column and the second join column satisfy a data pushdown condition is determined based on the first query statement, the data pushdown condition being determined based on whether there is an inclusion relationship between a domain of the first join column and a domain of the second join column; the first query statement is updated in response to determining that the data pushdown condition is satisfied, to obtain a second query statement, the second query statement to be used to perform data limitation and then perform an inner join operation on the data tables; and data query is performed on the first data table and the second data table based on the second query statement, to obtain a data query result. As such, when the data pushdown condition is satisfied, a data table can be first filtered, and then an inner join operation is performed, thereby reducing a data processing amount and improving data query performance.

### BRIEF DESCRIPTION OF DRAWINGS

To describe the technical solutions in the specific implementations of the present application more clearly, the following briefly describes the accompanying drawings needed for describing the specific implementations. Clearly, the accompanying drawings described below show some implementations of the present application, and a person of ordinary skill in the art can still derive other drawings from these accompanying drawings without making innovative efforts.

FIG. 1 is a flowchart illustrating a data query method according to an implementation of the present application;

FIGS. 2A and 2B are a detailed flowchart illustrating a data query method according to an implementation of the present application;

FIG. 3 is a structural block diagram illustrating a data query apparatus according to an implementation of the present application; and

FIG. 4 is a schematic structural diagram illustrating an electronic device according to an implementation of the present application.

### DESCRIPTION OF IMPLEMENTATIONS

The technical solutions in the present application are clearly and completely described below with reference to the accompanying drawings. Clearly, the described implementations are some but not all of the implementations of the present application. Based on the implementations of the present application, all other implementations obtained by a person of ordinary skill in the art without making innovative efforts fall within the protection scope of the present application. In addition, the following described technical features in different implementations of the present application can be combined with each other as long as they do not conflict with each other.

First, some terms in the implementations of the present application are described for ease of understanding by a person skilled in the art.

Terminal device: can be a mobile terminal, a fixed terminal, or a portable terminal, such as a mobile phone, a station, a unit, a device, a multimedia computer, a multimedia tablet, an Internet node, a communicator, a desktop computer, a laptop computer, a notebook computer, a netbook computer, a tablet computer, a personal communication system device, a personal navigation device, a personal digital assistant, an audio/video player, a digital camera/video camera, a positioning device, a television receiver, a radio broadcast receiver, an e-book device, a game device, or any combination thereof, including accessories and peripherals of these devices or any combination thereof. It can be further foreseen that the terminal device can support any type of user-specific interface (for example, a wearable device), etc.

Server: can be an independent physical server, or can be a server cluster or a distributed system including a plurality of physical servers, or can be a cloud server that provides a basic cloud computing service such as a cloud service, a cloud database, cloud computing, a cloud function, cloud storage, a network service, cloud communication, a middleware service, a domain name service, a security service, and a big data and artificial intelligence platform.

Inner join: is a relational algebra join manner, and returns equi-matched rows in two data tables.

Self join: is special equi-join in inner join query. Self join means that a table joins a current table of the table. In self join, two join columns that participate in join are essentially the same column, and all rows are in one-to-one correspondence. Therefore, any data table can be pushed down (that is, filtered). It should be noted that, because there may be a partition table in a database, columns that participate in join in self join need to satisfy the same table, the same column, and the same partition.

Base table: is a table that exists independently. One relationship corresponds to one table in a structured query language (SQL).

Derived table: is a subquery result set obtained based on a subquery statement included in a query statement, and is a temporary table with a name (that is, a virtual table).

Limit statement: is used to return a specified number of rows from a data query result set.

Filtering: means whether the number of rows in an output result of an operation is less than that in input data.

Foreign key: indicates a relationship between two tables. A field in one table corresponds to a field in the other table.

The following describes the technical ideas of the present application.

In actual service processing scenarios, after inner join is performed on two data tables, data pushdown usually needs to be performed via a limit statement to implement data limitation. For example, two data tables that participate in join are respectively a student data table and a student grade table, a join column in the student data table is student number, and a join column in the student grade table is also student number. If a student number in the first row of the student data table is 002, and a student number in the third row of the student grade table is also 002, it is determined that the first row equi-matches the third row, and the two rows are joined.

However, when the inner join operation and data limitation are performed on the two data tables, there are usually a relatively large quantity of invalid calculations, which consume a large quantity of system resources and time costs, resulting in poor data query performance.

In the conventional technologies, before left outer join, a data table usually can be pushed down, and then a left outer join operation is performed. However, this manner cannot be applied to a pushdown scenario of inner join.

Based on the disadvantage in the above related technologies, implementations of the present application provide a data query method and apparatus, an electronic device, and a storage medium, to reduce a data processing amount and improve data query performance during data query.

An implementation of the present application provides a data query method. The method can be applied to an electronic device. The present application imposes no limitation on a type of the electronic device, and the electronic device can be any type of device suitable for implementation, for example, a smartphone or a tablet computer. Details are omitted for simplicity in the present application. In this implementation of the present application, application to a database (for example, Ocean Base) is used as an example for description.

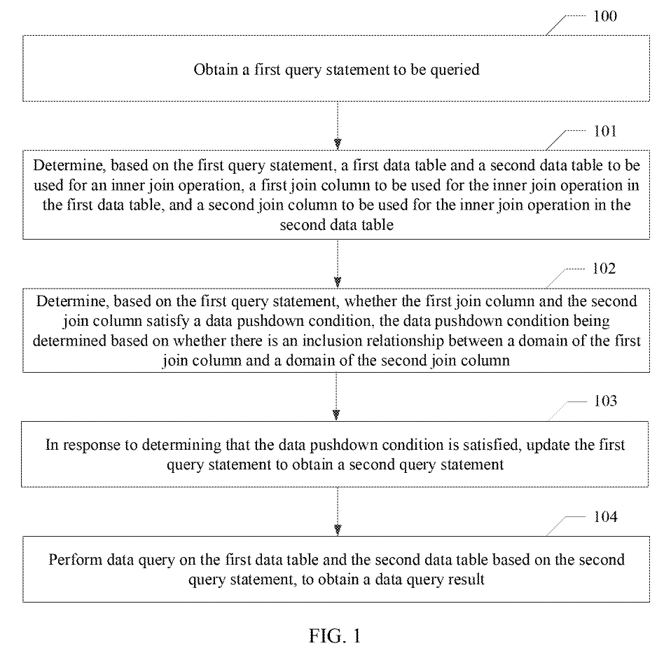

FIG. 1 is a flowchart illustrating a data query method according to an implementation of the present application. The following describes the method with reference to FIG. 1. The method includes step 100 to step 104.

Step 100: Obtain a first query statement to be queried.

The first query statement is a statement to be used to perform inner join on two data tables and then perform data limitation based on a limit clause. For example, the first query statement includes an inner join clause to be used to perform an inner join operation on a first data table and a second data table and a limit clause.

In an example, the inner join clause can be an INNER JOIN clause, or can be a JOIN clause, and is used to separately compare each record (that is, each row) in the first data table table1 with each record in the second data table table2 to identify each pair of records that satisfy equi-matching, and separately combine each pair of equi-matched records into a new result row. The limit clause is a clause to be used for data limitation, and data limitation can be implemented in a manner of data pushdown (for example, limit).

It should be noted that in this implementation of the present application, equi-matching of inner join means that a column value of a first join column in table1 is the same as a column value of a second join column in table2.

Step 101: Determine, based on the first query statement, the first data table and the second data table to be used for the inner join operation, the first join column to be used for the inner join operation in the first data table, and the second join column to be used for the inner join operation in the second data table.

For example, the first data table and the second data table are two data tables to be used for the inner join operation, and the first join column and the second join column are respectively join columns to be used for the inner join operation in the corresponding data tables.

In some implementations, the first query statement includes names respectively corresponding to the first data table, the first join column, the second data table, and the second join column. Therefore, the first data table, the first join column, the second data table, and the second join column can be directly obtained from the first query statement. In an example, the first query statement includes T1 and T2, and T1 and T2 are respectively table names of the first data table and the second data table.

In some implementations, at least one of the first data table, the first join column, the second data table, and the second join column is generated based on a clause in the first query statement. Therefore, the first query statement does not directly include a table name or a column name for inner join.

In an example, the first query statement includes T1 and a subquery statement q based on T1. T1 is the first data table, and a data table including the subquery statement q is the second data table.

Step 102: Determine, based on the first query statement, whether the first join column and the second join column satisfy a data pushdown condition.

The data pushdown condition is determined based on whether there is an inclusion relationship between a domain of the first join column and a domain of the second join column. It should be noted that a domain of a join column refers to a set of column values in the join column.

In some implementations, when step 102 is performed, steps S1021 to S1023 can be included.

S1021: Determine, based on the first query statement, whether an inclusion relationship determining condition is satisfied.

The inclusion relationship determining condition is determined based on a data table composition manner.

In some implementations, when S1021 is performed, the following manners can be used.

In a first manner, in response to determining, based on the first query statement, that both the first data table and the second data table are base tables, it is determined that the inclusion relationship determining condition is satisfied. It should be noted that a base table is a table that exists independently, and one relationship corresponds to one table in SQL.

In a second manner, in response to determining, based on the first query statement, that there is a derived table in one or more of the first data table or the second data table, whether the inclusion relationship determining condition is satisfied is determined based on a subquery statement corresponding to the derived table.

The derived table is a virtual table formed based on a subquery statement in the first query statement. The derived table is a subquery result set in a query process, and is a temporary table with a name. The name is given by a user in SQL. For example, for select * from (select * from authors) temp, temp is a derived table.

In some implementations, when the second manner is performed, the following manners can be used.

Manner 1: In response to determining that the subquery statement includes a specified join operator, determine that the inclusion relationship determining condition is not satisfied. The specified join operator is an operator used for join. In an example, the specified join operator can be join. In practice, the specified join operator can be set according to a practical application scenario, which is not limited herein.

Manner 2: In response to determining that the subquery statement includes an aggregation operator for a join column operation and does not include an extremum operator for an output operation of the aggregation operator, determine that the inclusion relationship determining condition is not satisfied.

In an example, the aggregation operator is aggr, and the extremum operator includes min and max. The subquery statement can include aggr and min, and is used to perform an aggregation operation on the first column (that is, a join column) of a data table by using the aggregation operator aggr, and then separately determine a minimum value of each aggregation by using the extremum operator min.

Manner 3: In response to determining that the subquery statement includes a specified filter operator and a filter range of the specified filter operator does not satisfy a specified filter condition, determine that the inclusion relationship determining condition is not satisfied.

In an example, the specified filter operator can include at least one of the following: where-condition, semi-join, and limit. The specified filter operator is an operator used for filtering. In practice, the specified filter operator can be set according to a practical application scenario, which is not limited herein.

In some implementations, filter ranges of the first data table and the second data table are separately determined based on the specified filter operator; and in response to that there is no coverage relationship between the filter ranges respectively corresponding to the first data table and the second data table, it is determined that the specified filter condition is not satisfied.

In an example, both the first data table and the second data table are derived tables, and are respectively generated based on a first subquery statement and a second subquery statement in the first query statement. The first subquery statement includes a first specified filter operator where id > 10, and the second subquery statement includes a second specified filter operator where id > 0. Clearly, a filter range of where id > 0 covers a filter range of where id > 10.

It should be noted that, if the first query statement includes only one specified filter operator, it can be determined that there is an inclusion relationship between the filter ranges of the two data tables. This is because an unfiltered global range definitely covers a filtered local range.

Manner 4: In response to determining that the subquery statement includes none of the specified join operator, the aggregation operator, and the specified filter operator, determine that the inclusion relationship determining condition is satisfied.

Manner 5: In response to determining that the subquery statement includes the aggregation operator and the extremum operator and includes neither of the specified join operator and the specified filter operator, determine that the inclusion relationship determining condition is satisfied.

Manner 6: In response to determining that the subquery statement includes the aggregation operator, the extremum operator, and the specified filter operator and does not include the specified join operator, and the specified filter condition is satisfied, determine that the inclusion relationship determining condition is satisfied.

S1022: In response to determining that the inclusion relationship determining condition is satisfied and there is a foreign key constraint relationship between the first join column and the second join column or the inner join operation is a self join operation, determine that there is the inclusion relationship.

It should be noted that at least two types of tables are needed for setting a foreign key constraint. A constrained table is referred to as a secondary table (child table), and the other table is referred to as a primary table (parent table), which belong to a primary-secondary relationship. The foreign key constraint is used to establish a link between data in the two tables, and a field (that is, another name of column) in one table is constrained by a corresponding field in the other table.

In an example, the first data table is a primary table, the second data table is a secondary table, and a join column in each of the first data table and the second data table is field A. In this case, field A in the first data table can be used as a foreign key of the second data table.

Therefore, a set (that is, a domain) of column values in the second join column is definitely included in the domain of the first join column.

Therefore, if there is the foreign key constraint relationship between the first join column and the second join column, it can be determined that there is the inclusion relationship.

In addition, self join is special equi-join in inner join query, and self join means that a table joins a current table of the table. Therefore, if a self join operation is performed on two data tables, an inner join operation is essentially performed on two tables that are the same. Therefore, if inner join is self join, there is definitely the inclusion relationship.

S1023: Determine, based on a specified predicate operator included in the first query statement in addition to the inner join clause, whether the data pushdown condition is satisfied.

In some implementations, the specified predicate operator can include at least one of the following functions: where-condition, order-by, and semi-join. The specified predicate operator can be an operator used for operations such as filtering, sorting, and semi-join. In practice, the specified predicate operator can be set according to a practical application scenario, which is not limited herein.

In some implementations, when S1023 is performed, the following manners can be used.

Manner 1: In response to determining that the first query statement does not include the specified predicate operator, determine that the data pushdown condition is satisfied.

Manner 2: In response to determining that the first query statement further includes the specified predicate operator and an associated data table of the specified predicate operator is consistent with a data table to which an included join column belongs, determine that the data pushdown condition is satisfied, or in response to determining that the first query statement does not include the specified predicate operator or the associated data table of the specified predicate operator is inconsistent with the data table to which the included join column belongs, determine that the data pushdown condition is not satisfied, the associated data table being a data table operated by the specified predicate operator.

For example, for ease of description, the data table to which the included join column belongs can be referred to as a target data table. If the domain of the first join column in the first data table includes the domain of the second join column in the second data table, the second data table is determined as the target data table; or if the domain of the first join column in the first data table does not include the domain of the second join column in the second data table, the first data table is determined as the target data table.

Step 103: In response to determining that the data pushdown condition is satisfied, update the first query statement to obtain a second query statement.

The second query statement is to be used to perform data limitation and then perform an inner join operation on the data tables.

In some implementations, when step 103 is performed, steps S1031 to S1034 can be included.

S1031: Use a data table, to which an included join column belongs, as a target data table based on the inclusion relationship.

S1032: Generate, based on the limit clause in the first query statement, a target clause to be used to perform data limitation on the target data table.

The target clause includes the limit clause, and in some implementations, can further include another clause to be used for filtering. The limit clause is a clause to be used for data limitation, for example, can be limit.

S1033: Generate a conditional clause to be used to restrain that a join column of the target data table is not null.

S1034: Combine the first query statement, the target clause, and the conditional clause to obtain the second query statement.

Step 104: Perform data query on the first data table and the second data table based on the second query statement, to obtain a data query result.

As such, data limitation can be first performed on the target data table by using the target clause generated based on the limit clause, and then inner join is performed on the processed data table based on the conditional clause being not null and the inner join clause.

It should be noted that, before the inner join operation is performed on the two data tables, a sufficient condition for pushing down the data table is as follows: There is an inclusion relationship between domains of two data columns that participate in the inner join operation, that is, there is no filtering in inner join. If the domain of the second join column includes the domain of the first join column, each row in the first data column can equi-match one or more rows in the second data column. Therefore, an inner join operation performed on the second data table and each non-null row in the first data table can be successful. The number of rows obtained after the inner join operation needs to be greater than the number of rows in the first data table. In this case, data pushdown is performed on the first data table, and semantics thereof is unchanged, that is, a finally obtained query result of the inner join operation is unchanged.

If the two data tables subjected to the inner join operation are both base tables, it is only necessary to check whether the join columns satisfy the foreign key constraint condition or whether self join is performed, and whether the associated data table related to the specified predicate operator is the target data table. If there is the derived table, whether the inclusion relationship determining condition is satisfied needs to be first determined based on the subquery statement forming the derived table, to determine whether another factor destroys the inclusion relationship. If it is determined that the inclusion relationship determining condition is satisfied, whether the derived table satisfies the foreign key constraint condition or whether self join is performed, and whether the data table related to the specified predicate operator is the included target data table are determined.

As such, when the data pushdown condition is satisfied, an inner join operation can be performed after the included target data table is pushed down, thereby reducing a data processing amount and consumed costs and improving data query performance.

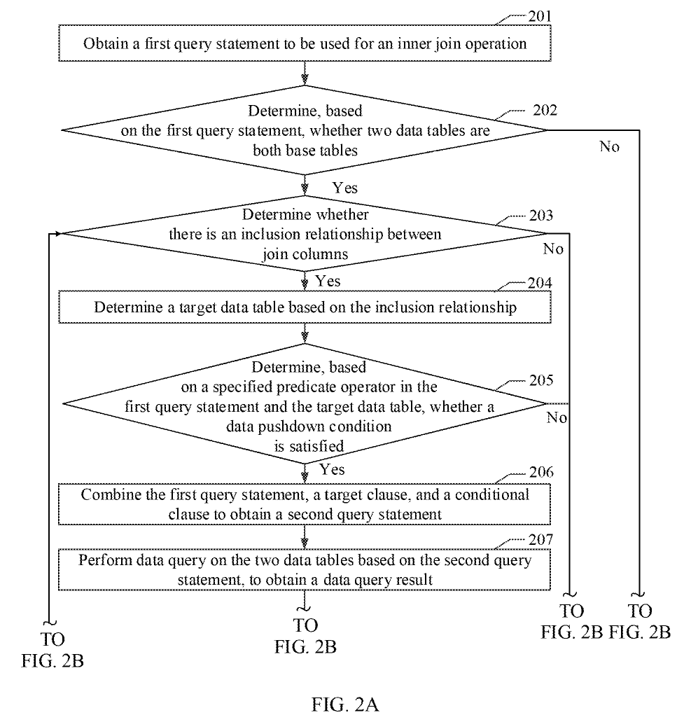

The following, illustratively describes the above implementation with reference to FIGS. 2A and 2B. FIGS. 2A and 2B are a detailed flowchart illustrating a data query method. The following describes the method with reference to FIGS. 2A and 2B. The method includes step 201 to step 214.

Step 201: Obtain a first query statement to be used for an inner join operation.

For example, when it is determined that a query statement to be processed is received, if the query statement to be processed is a statement to be used for the inner join operation, it is determined that the query statement to be processed is the first query statement.

Further, if the query statement to be processed is not a statement to be used for the inner join operation, the query statement to be processed is directly executed, or a join manner of the query statement to be processed is determined, and the query statement to be processed is executed based on another algorithm corresponding to the join manner.

Step 202: Determine, based on the first query statement, whether two data tables are both base tables; and if the two data tables are both base tables, perform step 203; or if the two data tables are not both base tables, perform step 209.

In some implementations, if a data table to be used for the inner join operation in the first query statement is a table that exists independently, the data table is a base table.

Further, if a data table to be used for the inner join operation in the first query statement is a virtual table formed based on a subquery statement in the first query statement, it is determined that the data table is a derived table.

Step 203: Determine whether there is an inclusion relationship between join columns; and if there is an inclusion relationship between the join columns, perform step 204; or if there is no inclusion relationship between the join columns, perform step 208.

For example, if there is a foreign key constraint relationship between the two join columns (that is, a first join column and a second join column) or the inner join operation is a self join operation, it is determined that there is the inclusion relationship; or if there is no foreign key constraint relationship between the two join columns or the inner join operation is not a self join operation, it is determined that there is no inclusion relationship.

Step 204: Determine a target data table based on the inclusion relationship.

Step 205: Determine, based on a specified predicate operator included in the first query statement in addition to an inner join clause and the target data table, whether a data pushdown condition is satisfied; and if the data pushdown condition is satisfied, perform step 206; or if the data pushdown condition is not satisfied, perform step 208.

For example, the specified predicate operator can include at least one of the following: where-condition, order-by, and semi-join. If an associated data table operated by the specified predicate operator is the target data table, that is, the specified predicate operator in the first query statement is used to perform operations such as filtering and sorting on the target data table, it is determined that the data pushdown condition is satisfied.

As such, if a data table (that is, the associated data table) related to the specified predicate operator and a data table to be pushed down (that is, the target data table) are the same table, the target data table can be pushed down.

Step 206: Combine the first query statement, a target clause, and a conditional clause to obtain a second query statement.

For example, the target clause to be used to perform data limitation on the target data table is generated based on a limit clause in the first query statement; the conditional clause to be used to restrain that a join column of the target data table is not null is generated; and the first query statement, the target clause, and the conditional clause are combined to obtain the second query statement.

This is because a row with a null value in the join column is not reserved in inner join. Therefore, a condition that the join column is not null needs to be added for the target data table to ensure semantic correctness.

Step 207: Perform data query on the two data tables based on the second query statement, to obtain a data query result.

For example, the target data table is first pushed down by using the second query statement, to obtain a pushed-down target data table, and then an inner join operation is performed on the pushed-down target data table and a remaining data table, to obtain the data query result.

The remaining data table is a data table other than the target data table in a first data table and a second data table, that is, a data table that includes the target data table in the first data table and the second data table.

Step 208: End the procedure.

Step 209: Obtain, from the first query statement, a subquery statement to be used to form a derived table.

The subquery statement is a SELECT clause to be used to form the derived table.

In an example, the first data table or the second data table is a derived table, and a corresponding subquery statement is obtained.

In another example, both the first data table and the second data table are derived tables, and subquery statements respectively corresponding to the first data table and the second data table are obtained.

As such, the derived table and the corresponding number of derived tables can be determined based on the subquery statement in the first query statement.

Step 210: Determine whether the subquery statement does not include a specified join operator; and if the subquery statement does not include the specified join operator, perform step 211; or if the subquery statement includes the specified join operator, perform step 208.

The specified join operator is a statement to be used for data join.

In an example, the specified join operator can be join.

Step 211: Determine whether an aggregation operator for a join column operation exists in the subquery statement; and if the aggregation operator for the join column operation exists in the subquery statement, perform step 212; or if the aggregation operator for the join column operation does not exist in the subquery statement, perform step 203.

The aggregation operator can be aggr.

Step 212: Determine whether an extremum operator for an output operation of the aggregation operator exists in the subquery statement; and if the extremum operator for the output operation of the aggregation operator exists in the subquery statement, perform step 213; or if the extremum operator for the output operation of the aggregation operator does not exist in the subquery statement, perform step 208.

A maximum operator can be max, and a minimum operator can be min.

Step 213: Determine whether a specified filter operator exists in the subquery statement; and if the specified filter operator exists in the subquery statement, perform step 214; or if the specified filter operator does not exist in the subquery statement, perform step 208.

The specified filter operator is an operator to be used for data filtering.

In some implementations, the specified filter operator can include at least one of the following: where-condition, semi-join, and limit.

Step 214: Determine whether a filter range of the specified filter operator satisfies a specified filter condition; and if the filter range of the specified filter operator satisfies the specified filter condition, perform step 203; or if the filter range of the specified filter operator does not satisfy the specified filter condition, perform step 208.

For example, when step 201 to step 214 are performed, for specific steps, references can be made to step 100 to step 104 above. Details are omitted herein for simplicity.

The following illustrates the above implementation with reference to a query statement. Data table t1 is created by using the following data table statement: create table t1(id int primary key, c1 int, c2 int). It can be learned from the data table statement that t1 includes three columns, field values of the columns are id, c1, and c2 respectively, and id is a primary key. A query statement Query for t1 is: SELECT *FROM (SELECT id, MAX (c1) AS aggr FROM t1 WHERE id >10 GROUP BY id) view1 JOIN (SELECT c1 FROM t1 WHERE id > 0) view2 ON view1.aggr = view2.c1 ORDER BY view1.id LIMIT 10;

First, whether the query statement is a first query statement to be used for an inner join operation is determined. For example, because the query statement includes an inner join character "JOIN", it is determined that the query statement is the first query statement to be used for the inner join operation. In addition, a first data table and a second data table for the inner join operation are view1 and view2 respectively. It can be learned from view1.aggr = view2.c1 that a first join column to be used for the inner join operation in view1 is view1.aggr, and a second join column to be used for the inner join operation in view2 is view2.c1.

Second, a table type of each data table is determined based on the first query statement. For example, the first query statement includes two subquery statements for forming a derived table, that is, a first subquery statement corresponding to view1: SELECT id, MAX (c1) AS aggr FROM t1 WHERE id >10 GROUP BY id, and a second subquery statement corresponding to view2: SELECT c1 FROM t1 WHERE id > 0. Therefore, both the first data table and the second data table of the first query statement are derived tables.

Then, it is determined that the subquery statements each include a specified join operator. Therefore, aggregation operator determining is performed on each subquery statement. For example, the first subquery statement includes an aggregation operator aggr for the first join column, and includes a maximum operator MAX (c1) for the aggregation operator, that is, a condition that there is no specified join operator but an aggregation operator for a join column operation and an extremum operator exist is satisfied. In addition, there is no specified join operator and no aggregation operator in the second subquery statement.

Further, whether the subquery statement includes a specified filter operator is determined. For example, the first subquery statement includes a specified filter operator for the first join column, that is, WHERE id > 10, and the second subquery statement includes a specified filter operator for the second join column, that is, WHERE id > 0. Therefore, a filter range of WHERE id > 0 covers a filter range of WHERE id > 10, and therefore an inclusion relationship determining condition is satisfied.

Then, whether there is an inclusion relationship between the join columns is determined. For example, the inner join operation is determined as a self join operation. This is because a column to which the first join column belongs is actually t1.c1, a column to which the second join column belongs is actually also t1.c1, and no partition exists in table t1. Therefore, the inner join operation is a self join operation. Therefore, it is determined that a domain of the first join column is included in a domain of the second join column, and the first data table is a target data table.

Then, update determining is performed based on a specified predicate operator included in the first query statement in addition to an inner join clause. For example, the inner join clause is a clause to be used for an inner join operation in the first query statement. The first query statement further includes a specified predicate operator ORDER BY, and it can be learned based on ORDER BY view1.id that ORDER BY is used to sort the first data table, that is, the target data table. Therefore, if a data pushdown condition is satisfied, a target clause, that is, ORDER BY id limit 10, is generated, to push down the first data table to implement data limitation.

Further, a conditional clause, that is, WHERE aggr IS NOT NULL, can be further generated, to restrain that a join column of the target data table is not null.

Then, a new first data table newview can be obtained by combining the first subquery statement with the target clause and the conditional clause: ((SELECT id, MAX(c1) AS aggr FROM t1 WHERE id > 10 GROUP BY id) WHERE aggr IS NOT NULL ORDER BY id limit 10).

Further, the first query statement is updated based on a new first subquery statement, to obtain a second query statement, that is: SELECT *FROM ((SELECT id, MAX(c1) AS aggr FROM t1 WHERE id > 10 GROUP BY id) WHERE aggr IS NOT NULL ORDER BY id limit 10) newview JOIN (SELECT c1 FROM t1 WHERE id > 0) view2 ON newview.aggr = view2.c1 ORDER BY newview.id LIMIT 10.

In the implementations of the present application, whether the data pushdown condition is satisfied is determined based on whether there is the inclusion relationship between the domain of the first join column and the domain of the second join column. If the data pushdown condition is satisfied, data pushdown is performed on the included target data table in the two data tables, and then the inner join operation is performed, thereby effectively reducing a data processing amount of join calculation and consumed system resources and time costs, and improving data processing efficiency and data query performance. Further, regardless of whether two sides of inner join are base tables or derived tables, whether pushdown can be performed before inner join can be determined. This can be applied to a complex scenario including a derived table, has a wide application scope, and provides convenience for a user.

User information (including but not limited to device information of a user, personal information of a user, etc.) and data (including but not limited to data used for analysis, stored data, displayed data, etc.) used in the present application are information and data that are authorized by the user or fully authorized by each party, related data needs to be collected, used, and processed by abiding by related laws and regulations and standards of a related country and region, and a corresponding operation entry is provided, so that the user chooses to perform authorization or rejection.

Based on the same inventive concept, an implementation of the present application further provides a data query apparatus. Because a problem-resolving principle of the above apparatus and device is similar to that of the data query method, for implementation of the apparatus, reference can be made to implementation of the method. Details are omitted for simplicity. The apparatus can be applied to an electronic device. The present application imposes no limitation on a type of the electronic device, and the electronic device can be any type of device suitable for implementation, for example, a smartphone or a tablet computer. Details are omitted for simplicity in the present application.

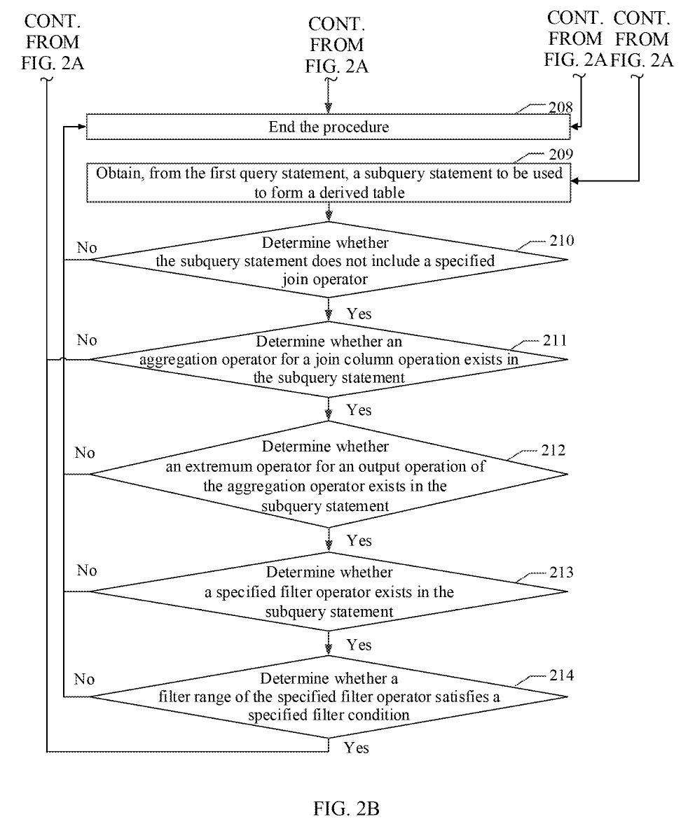

FIG. 3 is a structural block diagram illustrating a data query apparatus according to an implementation of the present application. In some implementations, the data query apparatus illustrated in the present application includes: an acquisition unit 301, configured to obtain a first query statement to be queried, the first query statement being a statement to be used to perform inner join on two data tables and then perform data limitation based on a limit clause; a determining unit 302, configured to determine, based on the first query statement, a first data table and a second data table to be used for an inner join operation, a first join column to be used for the inner join operation in the first data table, and a second join column to be used for the inner join operation in the second data table; a judgement unit 303, configured to determine, based on the first query statement, whether the first join column and the second join column satisfy a data pushdown condition, the data pushdown condition being determined based on whether there is an inclusion relationship between a domain of the first join column and a domain of the second join column; an update unit 304, configured to: in response to determining that the data pushdown condition is satisfied, update the first query statement to obtain a second query statement, the second query statement to be used to perform data limitation and then perform an inner join operation on the data tables; and a query unit 305, configured to perform data query on the first data table and the second data table based on the second query statement, to obtain a data query result.

In some implementations, the judgement unit 303 is configured to: determine, based on the first query statement, whether an inclusion relationship determining condition is satisfied, the inclusion relationship determining condition being determined based on a data table composition manner; in response to determining that the inclusion relationship determining condition is satisfied and there is a foreign key constraint relationship between the first join column and the second join column or the inner join operation is a self join operation, determine that there is the inclusion relationship; and determine, based on a specified predicate operator included in the first query statement in addition to an inner join clause, whether the data pushdown condition is satisfied, the inner join clause being a clause to be used for the inner join operation in the first query statement.

In some implementations, the judgement unit 303 is configured to: in response to determining, based on the first query statement, that both the first data table and the second data table are base tables, determine that the inclusion relationship determining condition is satisfied; and in response to determining, based on the first query statement, that there is a derived table in one or more of the first data table or the second data table, determine, based on a subquery statement corresponding to the derived table, whether the inclusion relationship determining condition is satisfied, the derived table being a virtual table formed based on a subquery statement in the first query statement.

In some implementations, the judgement unit 303 is configured to: in response to determining that the subquery statement includes a specified join operator, determine that the inclusion relationship determining condition is not satisfied; in response to determining that the subquery statement includes an aggregation operator for a join column operation and does not include an extremum operator for an output operation of the aggregation operator, determine that the inclusion relationship determining condition is not satisfied; in response to determining that the subquery statement includes a specified filter operator and a filter range of the specified filter operator does not satisfy a specified filter condition, determine that the inclusion relationship determining condition is not satisfied; in response to determining that the subquery statement includes none of the specified join operator, the aggregation operator, and the specified filter operator, determine that the inclusion relationship determining condition is satisfied; in response to determining that the subquery statement includes the aggregation operator and the extremum operator and includes neither of the specified join operator and the specified filter operator, determine that the inclusion relationship determining condition is satisfied; or in response to determining that the subquery statement includes the aggregation operator, the extremum operator, and the specified filter operator and does not include the specified join operator, and the specified filter condition is satisfied, determine that the inclusion relationship determining condition is satisfied.

In some implementations, the judgement unit 303 is configured to: separately determine filter ranges of the first data table and the second data table based on the specified filter operator; and in response to that there is no coverage relationship between the filter ranges respectively corresponding to the first data table and the second data table, determine that the specified filter condition is not satisfied.

In some implementations, the judgement unit 303 is configured to: in response to determining that the first query statement does not include the specified predicate operator, determine that the data pushdown condition is satisfied, or in response to determining that the first query statement includes the specified predicate operator, determine that the data pushdown condition is not satisfied; or in response to determining that the first query statement further includes the specified predicate operator and an associated data table of the specified predicate operator is consistent with a data table to which an included join column belongs, determine that the data pushdown condition is satisfied, or in response to determining that the first query statement does not include the specified predicate operator or the associated data table of the specified predicate operator is inconsistent with the data table to which the included join column belongs, determine that the data pushdown condition is not satisfied, the associated data table being a data table operated by the specified predicate operator.

In some implementations, the update unit 304 is configured to: use a data table, to which an included join column belongs, as a target data table based on the inclusion relationship; generate, based on the limit clause in the first query statement, a target clause to be used to perform data limitation on the target data table; generate a conditional clause to be used to restrain that a join column of the target data table is not null; and combine the first query statement, the target clause, and the conditional clause to obtain the second query statement.

In the data query method and apparatus, the electronic device, and the storage medium that are provided in the implementations of the present application, a first query statement to be queried is obtained, the first query statement being a statement to be used to perform inner join on two data tables and then perform data limitation based on a limit clause; a first data table and a second data table to be used for an inner join operation, a first join column to be used for the inner join operation in the first data table, and a second join column to be used for the inner join operation in the second data table are determined based on the first query statement; whether the first join column and the second join column satisfy a data pushdown condition is determined based on the first query statement, the data pushdown condition being determined based on whether there is an inclusion relationship between a domain of the first join column and a domain of the second join column; the first query statement is updated in response to determining that the data pushdown condition is satisfied, to obtain a second query statement, the second query statement to be used to perform data limitation and then perform an inner join operation on the data tables; and data query is performed on the first data table and the second data table based on the second query statement, to obtain a data query result. As such, when the data pushdown condition is satisfied, a data table can be first filtered, and then an inner join operation is performed, thereby reducing a data processing amount and improving data query performance.

An implementation of the present application provides an electronic device, including: a processor; and a memory, storing computer instructions. The computer instructions are used to enable the processor to perform the method in any one of the above implementations.

In an example configuration, the electronic device includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

An implementation of the present application provides a storage medium, storing computer instructions. The computer instructions are used to enable a computer to perform the method in any one of the above implementations.

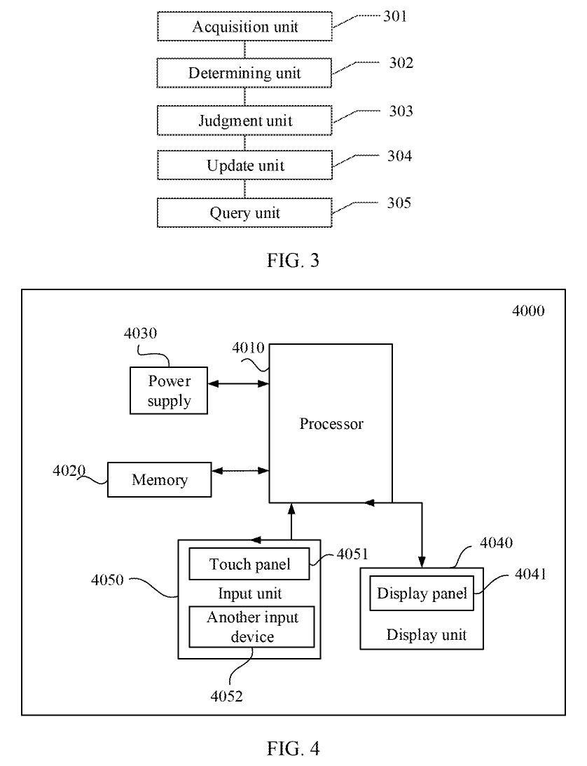

FIG. 4 is a schematic structural diagram illustrating an electronic device 4000. Referring to FIG. 4, the electronic device 4000 includes a processor 4010 and a memory 4020, and in some implementations, can further include a power supply 4030, a display unit 4040, and an input unit 4050.

The processor 4010 is a control center of the electronic device 4000, is connected to components through various interfaces and lines, and performs various functions of the electronic device 4000 by running or executing a software program and/or data stored in the memory 4020.

In this implementation of the present application, when invoking a computer program stored in the memory 4020, the processor 4010 performs the steps in the above implementations.

In some implementations, the processor 4010 can include one or more processing units. For example, an application processor and a modem processor can be integrated into the processor 4010. The application processor mainly processes an operating system, a user interface, an application, etc. The modem processor mainly processes wireless communication. It can be understood that the modem processor may alternatively not be integrated into the processor 4010. In some implementations, the processor and the memory can be implemented on a single chip. In some implementations, the processor and the memory can be implemented on separate chips.

The memory 4020 can mainly include a program storage area and a data storage area. The program storage area can store an operating system, various applications, etc. The data storage area can store data created based on use of the electronic device 4000, etc. In addition, the memory 4020 can include a high-speed random access memory, and can further include a non-volatile memory, such as at least one magnetic disk storage device, a flash storage device, or another volatile solid-state storage device.

The electronic device 4000 further includes the power supply 4030 (such as a battery) for supplying power to the components. The power supply can be logically connected to the processor 4010 by using a power management system, thereby implementing functions such as charging management, discharging management, and power consumption management by using the power management system.

The display unit 4040 can be configured to display information entered by a user or information provided for a user, various menus of the electronic device 4000, etc. In this implementation of the present application, the display unit is mainly configured to display a display interface of each application in the electronic device 4000 and objects such as a text and a picture that are displayed in the display interface. The display unit 4040 can include a display panel 4041. The display panel 4041 can be configured in a form of a liquid crystal display (LCD), an organic light-emitting diode (OLED), etc.

The input unit 4050 can be configured to receive information such as a number or a character entered by a user. The input unit 4050 can include a touch panel 4051 and another input device 4052. The touch panel 4051, also referred to as a touchscreen, can collect a touch operation performed by a user on or near the touch panel 4051 (for example, an operation performed by the user on or near the touch panel 4051 by using any suitable object or accessory such as a finger or a stylus).

For example, the touch panel 4051 can detect a touch operation of the user, detect a signal brought by the touch operation, convert the signal into touch point coordinates, send the touch point coordinates to the processor 4010, and receive and execute a command sent by the processor 4010. In addition, the touch panel 4051 can be implemented in a plurality of types, such as a resistive type, a capacitive type, an infrared type, and a surface acoustic wave type. The another input device 4052 can include but is not limited to one or more of a physical keyboard, a function button (for example, a volume control button or a power button), a trackball, a mouse, or a joystick.

Certainly, the touch panel 4051 can cover the display panel 4041. After detecting a touch operation on or near the touch panel 4051, the touch panel 4051 transmits the touch operation to the processor 4010 to determine a type of a touch event. Then, the processor 4010 provides a corresponding visual output on the display panel 4041 based on the type of the touch event. Although in FIG. 4, the touch panel 4051 and the display panel 4041 are used as two independent components to implement input and output functions of the electronic device 4000, in some implementations, the touch panel 4051 and the display panel 4041 can be integrated to implement the input and output functions of the electronic device 4000.

The electronic device 4000 can further include one or more sensors, such as a pressure sensor, a gravity acceleration sensor, and an optical proximity sensor. Certainly, based on a need in practice, the above electronic device 4000 can further include other components such as a camera. Because these components are not components mainly used in this implementation of the present application, the components are not shown in FIG. 4 and are not described in detail.

A person skilled in the art can understand that FIG. 4 is merely an example of the electronic device and does not constitute a limitation on the electronic device. The electronic device can include more or fewer components than those shown in the figure, or combine some components, or have different components.

For ease of description, the above parts are divided into modules (or units) based on functions for separate description. Certainly, when the present application is implemented, the functions of the modules (or units) can be implemented in one or more pieces of software or hardware.

Clearly, the above implementations are merely examples for clear description, but not limitations on the implementations. A person of ordinary skill in the art can further make other changes or variations in different forms based on the above description. It is neither necessary nor possible to exhaust all implementations herein. However, clear changes or variations derived from this still fall within the protection scope created by the present application.

1. A data query method, the method comprising:
obtaining a first query statement to be queried, the first query statement being a statement to be used to perform inner join on two data tables and then perform data limitation based on a limit clause;
determining, based on the first query statement, a first data table and a second data table to be used for an inner join operation, a first join column to be used for the inner join operation in the first data table, and a second join column to be used for the inner join operation in the second data table;
determining, based on the first query statement, whether the first join column and the second join column satisfy a data pushdown condition, the data pushdown condition being determined based on whether there is an inclusion relationship between a domain of the first join column and a domain of the second join column;
in response to determining that the data pushdown condition is satisfied, updating the first query statement to obtain a second query statement, the second query statement to be used to perform data limitation and an inner join operation on the data tables; and
performing data query on the first data table and the second data table based on the second query statement, to obtain a data query result.

2. The method according to claim 1, wherein the determining, based on the first query statement, whether the first join column and the second join column satisfy the data pushdown condition includes:
determining, based on the first query statement, whether an inclusion relationship determining condition is satisfied, the inclusion relationship determining condition being determined based on a data table composition manner;
in response to determining that the inclusion relationship determining condition is satisfied and there is a foreign key constraint relationship between the first join column and the second join column or the inner join operation is a self join operation, determining that there is the inclusion relationship; and
determining, based on a predicate operator included in the first query statement in addition to an inner join clause, whether the data pushdown condition is satisfied, the inner join clause being a clause to be used for the inner join operation in the first query statement.

3. The method according to claim 2, wherein the determining, based on the first query statement, whether the inclusion relationship determining condition is satisfied includes:
in response to determining, based on the first query statement, that both the first data table and the second data table are base tables, determining that the inclusion relationship determining condition is satisfied; and
in response to determining, based on the first query statement, that there is a derived table in one or more of the first data table or the second data table, determining, based on a subquery statement corresponding to the derived table, whether the inclusion relationship determining condition is satisfied, the derived table being a virtual table formed based on a subquery statement in the first query statement.

4. The method according to claim 3, wherein the determining, based on the subquery statement corresponding to the derived table, whether the inclusion relationship determining condition is satisfied includes:
in response to determining that the subquery statement includes a join operator, determining that the inclusion relationship determining condition is not satisfied;
in response to determining that the subquery statement includes an aggregation operator for a join column operation and does not include an extremum operator for an output operation of the aggregation operator, determining that the inclusion relationship determining condition is not satisfied;
in response to determining that the subquery statement includes a filter operator and a filter range of the filter operator does not satisfy a filter condition, determining that the inclusion relationship determining condition is not satisfied;
in response to determining that the subquery statement includes none of the join operator, the aggregation operator, and the filter operator, determining that the inclusion relationship determining condition is satisfied;
in response to determining that the subquery statement includes the aggregation operator and the extremum operator and includes neither of the join operator and the filter operator, determining that the inclusion relationship determining condition is satisfied; or
in response to determining that the subquery statement includes the aggregation operator, the extremum operator, and the filter operator and does not include the join operator, and the filter condition is satisfied, determining that the inclusion relationship determining condition is satisfied.

5. The method according to claim 4, wherein the in response to determining that the subquery statement includes the filter operator and the filter range of the filter operator does not satisfy the filter condition, determining that the inclusion relationship determining condition is not satisfied includes:
separately determining filter ranges of the first data table and the second data table based on the filter operator; and
in response to that there is no coverage relationship between the filter ranges respectively corresponding to the first data table and the second data table, determining that the filter condition is not satisfied.

6. The method according to claim 2, wherein the determining, based on the predicate operator included in the first query statement in addition to the inner join clause, whether the data pushdown condition is satisfied includes:
in response to determining that the first query statement does not include the predicate operator, determining that the data pushdown condition is satisfied, or in response to determining that the first query statement includes the predicate operator, determining that the data pushdown condition is not satisfied; or
in response to determining that the first query statement further includes the predicate operator and an associated data table of the predicate operator is consistent with a data table to which an included join column belongs, determining that the data pushdown condition is satisfied, or in response to determining that the first query statement does not include the predicate operator or the associated data table of the predicate operator is inconsistent with the data table to which the included join column belongs, determining that the data pushdown condition is not satisfied, the associated data table being a data table operated by the predicate operator.

7. The method according to claim 1, wherein the updating the first query statement, to obtain the second query statement includes:
using a data table, to which an included join column belongs, as a target data table based on the inclusion relationship;
generating, based on the limit clause in the first query statement, a target clause configured to perform data filtering on the target data table;
generating a conditional clause configured to restrain that a join column of the target data table is not null; and
combining the first query statement, the target clause, and the conditional clause to obtain the second query statement.

8. An electronic device, comprising:
one or more processors; and
one or more memory devices, individually or collectively, having computer instructions stored thereon, the computer instructions, when executed by the one or more processors, enabling the one or more processors to, individually or collectively, perform actions including:
obtaining a first query statement to be queried, the first query statement being a statement to be used to perform inner join on two data tables and then perform data limitation based on a limit clause;
determining, based on the first query statement, a first data table and a second data table to be used for an inner join operation, a first join column to be used for the inner join operation in the first data table, and a second join column to be used for the inner join operation in the second data table;
determining, based on the first query statement, whether the first join column and the second join column satisfy a data pushdown condition, the data pushdown condition being determined based on whether there is an inclusion relationship between a domain of the first join column and a domain of the second join column;
in response to determining that the data pushdown condition is satisfied, updating the first query statement to obtain a second query statement, the second query statement to be used to perform data limitation and an inner join operation on the data tables; and
performing data query on the first data table and the second data table based on the second query statement, to obtain a data query result.

9. The electronic device according to claim 8, wherein the determining, based on the first query statement, whether the first join column and the second join column satisfy the data pushdown condition includes:
determining, based on the first query statement, whether an inclusion relationship determining condition is satisfied, the inclusion relationship determining condition being determined based on a data table composition manner;
in response to determining that the inclusion relationship determining condition is satisfied and there is a foreign key constraint relationship between the first join column and the second join column or the inner join operation is a self join operation, determining that there is the inclusion relationship; and
determining, based on a predicate operator included in the first query statement in addition to an inner join clause, whether the data pushdown condition is satisfied, the inner join clause being a clause to be used for the inner join operation in the first query statement.

10. The electronic device according to claim 9, wherein the determining, based on the first query statement, whether the inclusion relationship determining condition is satisfied includes:
in response to determining, based on the first query statement, that both the first data table and the second data table are base tables, determining that the inclusion relationship determining condition is satisfied; and
in response to determining, based on the first query statement, that there is a derived table in one or more of the first data table or the second data table, determining, based on a subquery statement corresponding to the derived table, whether the inclusion relationship determining condition is satisfied, the derived table being a virtual table formed based on a subquery statement in the first query statement.

11. The electronic device according to claim 10, wherein the determining, based on the subquery statement corresponding to the derived table, whether the inclusion relationship determining condition is satisfied includes:
in response to determining that the subquery statement includes a join operator, determining that the inclusion relationship determining condition is not satisfied;
in response to determining that the subquery statement includes an aggregation operator for a join column operation and does not include an extremum operator for an output operation of the aggregation operator, determining that the inclusion relationship determining condition is not satisfied;
in response to determining that the subquery statement includes a filter operator and a filter range of the filter operator does not satisfy a filter condition, determining that the inclusion relationship determining condition is not satisfied;
in response to determining that the subquery statement includes none of the join operator, the aggregation operator, and the filter operator, determining that the inclusion relationship determining condition is satisfied;
in response to determining that the subquery statement includes the aggregation operator and the extremum operator and includes neither of the join operator and the filter operator, determining that the inclusion relationship determining condition is satisfied; or
in response to determining that the subquery statement includes the aggregation operator, the extremum operator, and the filter operator and does not include the join operator, and the filter condition is satisfied, determining that the inclusion relationship determining condition is satisfied.

12. The electronic device according to claim 11, wherein the in response to determining that the subquery statement includes the filter operator and the filter range of the filter operator does not satisfy the filter condition, determining that the inclusion relationship determining condition is not satisfied includes:
separately determining filter ranges of the first data table and the second data table based on the filter operator; and
in response to that there is no coverage relationship between the filter ranges respectively corresponding to the first data table and the second data table, determining that the filter condition is not satisfied.

13. The electronic device according to claim 9, wherein the determining, based on the predicate operator included in the first query statement in addition to the inner join clause, whether the data pushdown condition is satisfied includes:
in response to determining that the first query statement does not include the predicate operator, determining that the data pushdown condition is satisfied, or in response to determining that the first query statement includes the predicate operator, determining that the data pushdown condition is not satisfied; or
in response to determining that the first query statement further includes the predicate operator and an associated data table of the predicate operator is consistent with a data table to which an included join column belongs, determining that the data pushdown condition is satisfied, or in response to determining that the first query statement does not include the predicate operator or the associated data table of the predicate operator is inconsistent with the data table to which the included join column belongs, determining that the data pushdown condition is not satisfied, the associated data table being a data table operated by the predicate operator.

14. The electronic device according to claim 8, wherein the updating the first query statement, to obtain the second query statement includes:
using a data table, to which an included join column belongs, as a target data table based on the inclusion relationship;
generating, based on the limit clause in the first query statement, a target clause configured to perform data filtering on the target data table;
generating a conditional clause configured to restrain that a join column of the target data table is not null; and
combining the first query statement, the target clause, and the conditional clause to obtain the second query statement.

15. A storage medium, having computer instructions stored thereon, the computer instructions, when executed by one or more processors, enabling the one or more processors to, individually or collectively, perform actions comprising:
obtaining a first query statement to be queried, the first query statement being a statement to be used to perform inner join on two data tables and then perform data limitation based on a limit clause;
determining, based on the first query statement, a first data table and a second data table to be used for an inner join operation, a first join column to be used for the inner join operation in the first data table, and a second join column to be used for the inner join operation in the second data table;
determining, based on the first query statement, whether the first join column and the second join column satisfy a data pushdown condition, the data pushdown condition being determined based on whether there is an inclusion relationship between a domain of the first join column and a domain of the second join column;
in response to determining that the data pushdown condition is satisfied, updating the first query statement to obtain a second query statement, the second query statement to be used to perform data limitation and an inner join operation on the data tables; and
performing data query on the first data table and the second data table based on the second query statement, to obtain a data query result.

16. The storage medium according to claim 15, wherein the determining, based on the first query statement, whether the first join column and the second join column satisfy the data pushdown condition includes:
determining, based on the first query statement, whether an inclusion relationship determining condition is satisfied, the inclusion relationship determining condition being determined based on a data table composition manner;
in response to determining that the inclusion relationship determining condition is satisfied and there is a foreign key constraint relationship between the first join column and the second join column or the inner join operation is a self join operation, determining that there is the inclusion relationship; and
determining, based on a predicate operator included in the first query statement in addition to an inner join clause, whether the data pushdown condition is satisfied, the inner join clause being a clause to be used for the inner join operation in the first query statement.

17. The storage medium according to claim 16, wherein the determining, based on the first query statement, whether the inclusion relationship determining condition is satisfied includes:
in response to determining, based on the first query statement, that both the first data table and the second data table are base tables, determining that the inclusion relationship determining condition is satisfied; and
in response to determining, based on the first query statement, that there is a derived table in one or more of the first data table or the second data table, determining, based on a subquery statement corresponding to the derived table, whether the inclusion relationship determining condition is satisfied, the derived table being a virtual table formed based on a subquery statement in the first query statement.

18. The storage medium according to claim 17, wherein the determining, based on the subquery statement corresponding to the derived table, whether the inclusion relationship determining condition is satisfied includes:
in response to determining that the subquery statement includes a join operator, determining that the inclusion relationship determining condition is not satisfied;
in response to determining that the subquery statement includes an aggregation operator for a join column operation and does not include an extremum operator for an output operation of the aggregation operator, determining that the inclusion relationship determining condition is not satisfied;
in response to determining that the subquery statement includes a filter operator and a filter range of the filter operator does not satisfy a filter condition, determining that the inclusion relationship determining condition is not satisfied;
in response to determining that the subquery statement includes none of the join operator, the aggregation operator, and the filter operator, determining that the inclusion relationship determining condition is satisfied;
in response to determining that the subquery statement includes the aggregation operator and the extremum operator and includes neither of the join operator and the filter operator, determining that the inclusion relationship determining condition is satisfied; or
in response to determining that the subquery statement includes the aggregation operator, the extremum operator, and the filter operator and does not include the join operator, and the filter condition is satisfied, determining that the inclusion relationship determining condition is satisfied.

19. The storage medium according to claim 18, wherein the in response to determining that the subquery statement includes the filter operator and the filter range of the filter operator does not satisfy the filter condition, determining that the inclusion relationship determining condition is not satisfied includes:
separately determining filter ranges of the first data table and the second data table based on the filter operator; and
in response to that there is no coverage relationship between the filter ranges respectively corresponding to the first data table and the second data table, determining that the filter condition is not satisfied.

20. The storage medium according to claim 16, wherein the determining, based on the predicate operator included in the first query statement in addition to the inner join clause, whether the data pushdown condition is satisfied includes:
in response to determining that the first query statement does not include the predicate operator, determining that the data pushdown condition is satisfied, or in response to determining that the first query statement includes the predicate operator, determining that the data pushdown condition is not satisfied; or
in response to determining that the first query statement further includes the predicate operator and an associated data table of the predicate operator is consistent with a data table to which an included join column belongs, determining that the data pushdown condition is satisfied, or in response to determining that the first query statement does not include the predicate operator or the associated data table of the predicate operator is inconsistent with the data table to which the included join column belongs, determining that the data pushdown condition is not satisfied, the associated data table being a data table operated by the predicate operator.
